(19) United States
(12) Patent Application Publication
(10) Pub. No.: US 2003/0188190 A1
(43) Pub. Date: Oct. 2, 2003

(54) System and method of intrusion detection employing broad-scope monitoring

(76) Inventors: Jeffrey A. Aaron, Atlanta, GA (US); Thomas Anschutz, Conyers, GA (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/107,469

(22) Filed: Mar. 26, 2002

(51) Int. Cl. H04L 9/00

(52) U.S. Cl. 713/201

(57) ABSTRACT

A broad-scope intrusion detection system analyzes traffic coming into multiple hosts or other customers' computers or sites. This provides additional data for analysis as compared to systems that just analyze the traffic coming into one customer's site. Additional detection schemes can be used to recognize patterns that would otherwise be difficult or impossible to recognize with just a single customer detector. Standard signature detection methods can be used. Additionally, new signatures can be used based on broad-scope analysis goals.

### FIELD OF THE INVENTION

The present invention relates in general to intrusion detection systems for computer systems and, more particularly, to network-based intrusion detection systems.

### BACKGROUND OF THE INVENTION

Numerous present-day computer installations, be they provided with centralized processor units or be they organized in networks interconnecting geographically distributed processor units, have various access points for serving their users. The number of such points and the ease with which they are often accessible have the drawback of facilitating attempts at intrusion by people who are not authorized users and attempts by users of any kind, whether acting alone or in concert, to perform computer operations which such users should not be capable of performing legitimately. These unauthorized users are typically called “hackers” or “crackers”.

Moreover, the open network architecture of the Internet permits a user on a network to have access to information on many different computers, and it also provides access to messages generated by a user's computer and to the resources of the user's computer. Hackers present a significant security risk to any computer coupled to a network where a user for one computer may attempt to gain unauthorized access to resources on another computer of the network.

In an effort to control access to a network and, hence, limit unauthorized access to computer resources available on that network, a number of computer communication security devices and techniques have been developed. One type of device which is used to control the transfer of data is typically called a “firewall”. Firewalls are routers which use a set of rules to determine whether a data message should be permitted to pass into or out of a network before determining an efficient route for the message if the rules permit further transmission of the message.

One fundamental technique used by firewalls to protect network elements is known as “packet filtering”. A packet filter may investigate address information contained in a data packet to determine whether the source machine, from which the packet originated, is on a list of allowed addresses. If the address is on the list, the packet is allowed to pass. Otherwise the packet is dropped. Packet filtering using lists of allowed protocols (e.g., file transfer FTP, web access HTTP, email POP) is also sometimes done, either alone or in combination with the more stringent address-based packet filtering method.

One problem with address-based packet filtering is that hackers have developed a technique known as “address spoofing” or “IP spoofing” wherein address information within a fabricated packet is manipulated to bypass a packet filter (e.g., by placing the address information of a machine which is on the allowed list within the packet, even though the true source address which would normally be placed within the packet is different and disallowed). Address spoofing may also be used to make it appear that the packet originates in the network that the firewall protects, and thus is on a default allowed list.

An example of a conventional firewall arrangement is depicted in FIG. 1. A host computer 100 communicates with an institutional computer system 106 over a public network 102 through a router 104. A router is a network element that directs a packet in accordance with address information contained in the packet. The institutional computer system 106 supports a variety of applications including a Web server 108, and an e-mail system 114. A firewall system 110 with ports 111, 112, 113 is placed between the router 104 and the institutional computer 106. Port 112 connects an internal network 116 to the firewall 110, while ports 111 and 113 connect the public network 102 and the institutional computer 106, respectively. The internal network 116 may support communication between internal terminal(s) 118 and a database 120, possibly containing sensitive information. Such a firewall system 110, however, although intended to protect resources 118 and 120 connected to the internal network 116, is subject to attack in many ways.

A hacker operating the host computer 100 can utilize publicly accessible applications on the institutional computer system 106, such as the Web server 108 or the e-mail system 114, to attack the firewall system 110 or connect to the internal network port 112. The Web server 108 or the e-mail system 114 may have authority to attach to and communicate through the firewall system 110. The hacker might be able to exploit this by routing packets through, or mimicking these network elements, in order to attach to, attack, or completely bypass, the firewall system 110.

Most conventional firewalls, unless configured otherwise, are transparent to packets originating from behind the firewall. Hence, the hacker may insert a source address of a valid network element residing behind the firewall 110, such as the terminal 118, to a fictitious packet. Such a packet may then be able to pass through the firewall system 110. The hacker may even set the packet to be configured to contain a message requesting the establishment of a session with the terminal 118. The terminal 118 typically performs no checking itself, instead relying on the firewall, and assumes that such a session request is legitimate. The terminal 118 acknowledges the request and sends a confirmation message back through the firewall system 110. The ensuing session may appear to be valid to the firewall system 110.

The hacker can also initiate multiple attempts to attach to the port 111. Technically, a connection to the port is formed before the firewall 110 is able to filter the authority of the request. If enough connection requests hit the port 112, it may be rendered unavailable for a period of time, denying service to both incoming requests from the public network, and more importantly, denying access to the internal network 116 for outgoing messages. It is readily apparent that conventional firewall systems, such as the one depicted in FIG. 1, are unacceptably vulnerable in many ways.

Hackers have also developed other ways which may be helpful in bypassing the screening function of a router. For example, one computer, such as a server on the network, may be permitted to receive sync messages from a computer outside the network. In an effort to get a message to another computer on a network, a hacker may attempt to use source routing to send a message from the server to another computer on the network. Source routing is a technique by which a source computer may specify an intermediate computer on the path for a message to be transmitted to a destination computer. In this way, the hacker may be able to establish a communication connection with a server through a router and thereafter send a message to another computer on the network by specifying the server as an intermediate computer for the message to the other computer.

In an effort to prevent source routing techniques from being used by hackers, some routers (including some firewalls) may be configured to intercept and discard all source routed messages to a network. For a router configured with source routing blocking, the router may have a set of rules for inbound messages, a set of rules for outbound messages and a set of rules for source routing messages. When a message which originated from outside the network is received by such a router, the router determines if it is a source routed message. If it is, the router blocks the message if the source routing blocking rule is activated. If blocking is not activated, the router allows the source routed message through to the network. If the message is not a source routed message, the router evaluates the parameters of the message in view of the rules for receiving messages from sources external to the network. However, a router vulnerability exists where the rules used by the router are only compared to messages that are not source routed and the source routed blocking rule is not activated. In this situation, the router permits source routed messages through without comparing them to the filtering rules. In such a case, a computer external to the network may be able to bypass the external sync message filter and establish a communication connection with a computer on the network by using source routed messages.

A typical secure computer network has an interface for receiving and transmitting data between the secure network and computers outside the secure network. A plurality of network devices are typically behind the firewall. The interface may be a modem or an Internet Protocol (IP) router. Data received by the modem is sent to a firewall. Although the typical firewall is adequate to prevent outsiders from accessing a secure network, hackers and others can often breach a firewall. This can occur by a variety of methods of cyber attack which cause the firewall to permit access to an unauthorized user. An entry by an unauthorized computer into the secured network, past the firewall, from outside the secure network is called an intrusion. This is one type of unauthorized operation on the secure computer network.

There are systems available for determining that a breach of computer security has occurred, is underway, or is beginning. These systems can broadly be termed “intrusion detection systems”. Existing intrusion detection systems can detect intrusions and misuses. The existing security systems determine when computer misuse or intrusion occurs. Computer misuse detection is the process of detecting and reporting uses of processing systems and networks that would be deemed inappropriate or unauthorized if known to responsible parties, administrators, or owners. An intrusion is an entry to a processing system or network by an unauthorized outsider.

Misuse detection and reporting research has followed two basic approaches: anomaly detection systems and expert systems.

Anomaly detection systems look for statistically anomalous behavior. Statistical scenarios can be implemented for user, dataset, and program usage to detect “exceptional” use of the system. Since anomaly detection techniques do not directly detect misuse, they do not always detect most actual misuses. The assumption that computer misuses would appear statistically anomalous has been proven unreliable. When recordings or scripts of known attacks and misuses are replayed on computers with statistical anomaly detection systems, few if any of these scripts are identified as anomalous. This occurs for a variety of reasons which reduce the indirect detection accuracy.

In general, anomaly detection techniques cannot detect particular instances of misuses unless the specific behaviors associated with those misuses also satisfy statistical tests (e.g., regarding network data traffic or computer system activity) without security relevance. Anomaly detection techniques also produce false alarms. Most of the reported anomalies are purely coincidental statistical exceptions and do not reflect actual security problems. These false alarms often cause system managers to resist using anomaly detection methods because they increase the processing system workload and need for expert oversight without substantial benefits.

Another limitation with anomaly detection approaches is that user activities are often too varied for a single scenario, resulting in many inferred security events and associated false alarms. Statistical measures also are not sensitive to the order in which events occur, and this may prevent detection of serious security violations that exist when events occur in a particular order. Scenarios that anomaly detection techniques use also may be vulnerable to conscious manipulation by users. Consequently, a knowledgeable perpetrator may train the adaptive threshold of detection system scenarios over time to accept aberrant behaviors as normal. Furthermore, statistical techniques that anomaly detection systems use require complicated mathematical calculations and, therefore, are usually computationally expensive.

Expert systems (also known as rule-based systems) have had some use in misuse detection, generally as a layer on top of anomaly detection systems for interpreting reports of anomalous behavior. Since the underlying model is anomaly detection, they have the same drawbacks of anomaly detection techniques. Expert systems attempt to detect intrusions by taking surveillance data supplied by a security system of the computer installation and by applying knowledge thereto relating to potential scenarios for attacking the computer installation. This is not fully satisfactory either, since that method only detects intrusions that correspond to attack scenarios that have previously been stored.

In contrast to the two research approaches, most recent practical attempts at detecting misuse have relied on a signature or pattern-detection mechanism with a signature being the set of events and transitions/functions that define the sequence of actions that form an attack or misuse. A signature mechanism uses network sensors to detect data traffic or audit trail records typically generated by computer operating systems. The designer of the product which incorporates the mechanism selects a plurality of events that together form the signature or the attack or misuse. Although the signature mechanism goes a step beyond expert systems, it is similar to an expert system because it relies upon signatures or rules.

Importantly, intrusion detection methods used today are plagued by false positive events, and the inability to detect the earliest stages of network attacks. Conventional intrusion detection techniques are based on specialized equipment located at a specific customer's premises and hence cannot see the hacker's activities over a broader scale. A need exists for an intrusion detection system which can provide early warning of potential misuses and intrusions with greater knowledge than can be obtained from detection at a single customer's premises. Early warning can be provided by specially examining detection events over a broader scale or scope, i.e., that of many aggregated customers or of the intervening network.

Intrusion detection products and services presently available are directed to the analysis of a single customer's data to determine intrusion events, but lack the capability to perform broad-scope intrusion analysis/detection.

It is readily apparent that the design, implementation, and limitations of conventional firewalls has rendered them highly vulnerable to hacker attack. What is needed is an improved firewall functionality or system that overcomes the foregoing disadvantages and is resistant to hacker attack.

It is also readily apparent that the design, implementation, and limitations of conventional intrusion/misuse detection systems has rendered them unreliable and inefficient. Furthermore, these intrusion detection systems are vulnerable to hacker techniques which render them insensitive to misuse. What is needed is an improved intrusion detection functionality or system that overcomes the foregoing disadvantages and is resistant to hacker attack.

“Pre-attack” events are not detectable or predictable by conventional intrusion detection systems. Attacks can only be detected afterwards, or while they are occurring, rather than predicted based on initial events. Being able to “detect” these initial events (pre-attack events) means being able to determine that such events do in fact likely indicate a coming attack. Thus, there is a need for broad-scope processing that can make such a determination, thereby solving the current problems.

### SUMMARY OF THE INVENTION

The present invention is directed to a system and method for broad-scope intrusion detection. The system analyzes traffic coming into multiple hosts or other customers' computers or sites. This provides additional data for analysis as compared to systems that just analyze the traffic coming into one customer's site (as a conventional intrusion detection system does). Therefore, additional detection schemes can be used to recognize patterns that would otherwise be difficult or impossible to recognize with just a single customer detector. Standard signature detection methods can be used. Additionally, new signatures and methods/algorithms can be used based on broad-scope analysis goals.

According to an embodiment of the invention, an intrusion detection system for a computer network comprises a plurality of devices coupled to the computer network, and a data collection and processing center comprising a computer with a firewall coupled to the computer network, the data collection and processing center monitoring data communicated to the plurality of devices coupled to the network. The plurality of devices comprises at least one of a host, a server, and a personal computer.

According to aspects of the invention, a firewall is associated with each of the plurality of devices, each firewall connecting the associated device to the computer network. Moreover, the data collection and processing center further comprises a storage device comprising a plurality of pattern recognition techniques. It is contemplated that the pattern recognition techniques comprise at least one of sequential and pseudorandom algorithms.

According to further aspects of the invention, the data collection and processing center further comprises a bus, a processor coupled to the bus, a storage device coupled to the bus, and a communications interface that couples the data collection and processing center to the plurality of devices via an authenticated secured connection. The processor executes a plurality of pattern recognition algorithms on the data communicated to the plurality of devices coupled to the network. Moreover, the data collection and processing provides an alarm if the data indicates an anomaly.

According to an additional aspect of the invention, the computer network is a wired local network or a wireless network.

According to an additional aspect of the invention, the data collection and processing center may be coupled to the computer network via wired or wireless links, or via specific/special wire-line network connections.

The foregoing and other aspects of the present invention will become apparent from the following detailed description of the invention when considered in conjunction with the accompanying drawings.

### BRIEF DESCRIPTION OF THE DRAWINGS

FIG. 1 depicts a computer network arrangement having a conventional firewall arrangement;

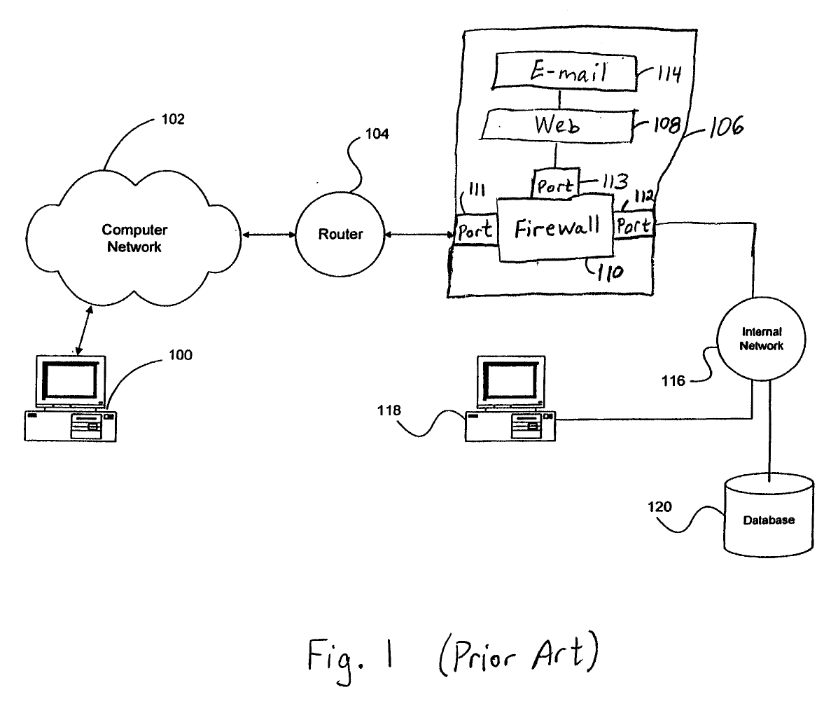

FIG. 2 shows in, schematic form, a computer network system including an intrusion detection system in accordance with the present invention;

FIG. 3 is a detailed block diagram of an exemplary computer system with which the present invention can be used;

FIG. 4 shows in block form aspects of the intrusion detection system in accordance with the present invention;

FIG. 5 shows a flow chart of an exemplary intrusion detection method in accordance with the present invention; and

FIG. 6 shows a flow chart of another exemplary intrusion detection method in accordance with the present invention.

### DESCRIPTION OF EXEMPLARY EMBODIMENTS AND BEST MODE

The invention uses components, such as a computer system with a multi-tasking operating system, a network interface card, and network surveillance software, acting together to provide system functionality. This combination of hardware and software attached to a network is described more fully below and will perform the processes described below.

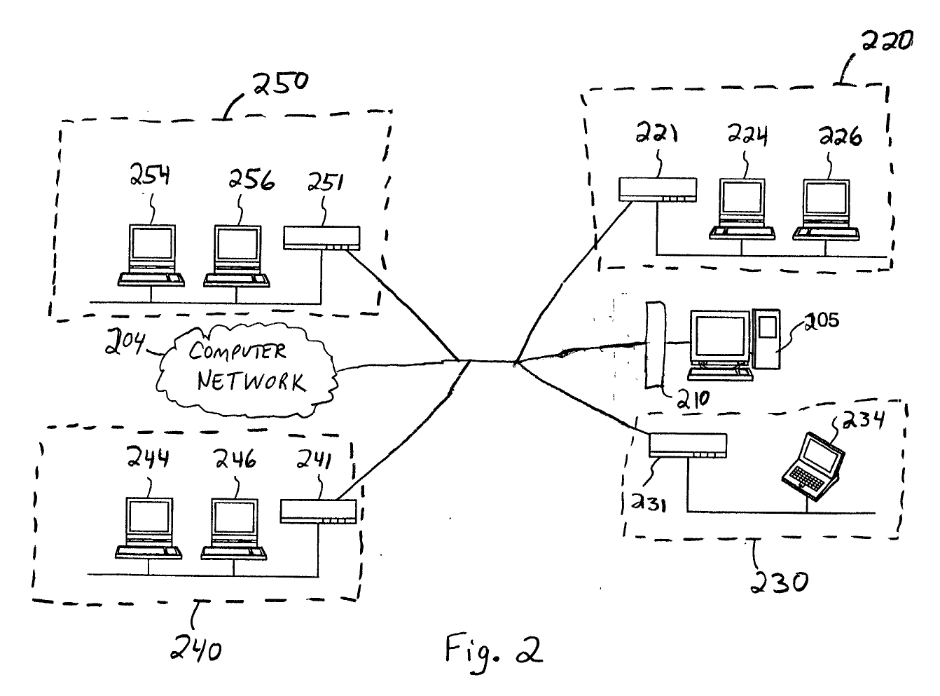

FIG. 2 shows in, schematic form, a computer network system including an intrusion detection system in accordance with the present invention. A plurality of network devices such as hosts, servers, and personal computers attached within customer site networks (shown here as customer site networks 220, 230, 240, 250), are shown coupled to an intervening computer network 204, such as a public network like the Internet. Routers (not shown) are typically used in the coupling. The customer site networks represent “internal” protected networks local to a particular corporation or site, for example. The customer site networks may or may not be publicly accessible or may comprise a publicly accessible network and an internal “private” network. Each customer site network or LAN (Local Area Network) comprises one or more hosts (e.g., customer site network 220 is shown with hosts 224, 226; customer site network 230 is shown with host 234; customer site network 240 is shown with hosts 244, 246; and customer site network 250 is shown with hosts 254, 256). Each site network is connected to the intervening computer network 204 via a firewall (e.g., host 220 is shown with firewall 221; host 230 is shown with firewall 231; host 240 is shown with firewall 241; and host 250 is shown with firewall 251).

A firewall connects the network 204 to an internal network. The firewall is a combination hardware and software buffer that is between the internal network and external devices outside the internal computer network. The firewall allows only specific kinds of messages to flow in and out of the internal network. As is known, firewalls are used to protect the internal network from intruders or hackers who might try to break into the internal network. The firewall is coupled to an interface (not shown). The interface is external to the internal network and can be a modem or an Internet Protocol (IP) router and serves to connect the internal network to devices outside the internal network.

A separately maintained data collection and processing center, comprising a computer or server 205 with firewall 210, is also coupled to the computer network. Although the data collection and processing center is implemented as a network device which is part of a wired local network, it is also envisioned as possibly being connected to the network 204 by a wireless link.

Each network device can be considered a node because each device has an addressable interface on the network. As can be appreciated, many other devices can be coupled to the network including additional personal computers, mini-mainframes, mainframes and other devices not illustrated or described which are well known in the art.

The system performs broad-scope intrusion detection by monitoring the communications on a network or on a particular segment of the network. The data collection and processing center receives information from the various network devices attached to the computer network 204. For example, all communications sent to each host 220, 230, 240, 250 are forwarded to, or otherwise captured by, the data collection and processing center. Thus, the data collection and processing center receives all communications (i.e., the data) originating from a user on the computer network 204 and flowing to host 220 (and vice versa), for example, as well as all communications originating from the computer network 204 and flowing to all other hosts (and vice versa).

It should be noted that certain devices can be used as sensors to sense data traffic and pass their findings on to the data collection and processing center or other central processing system, and other separate devices may include computer hosts, firewalls, and other systems which may be the potential targets of attack by a hacker, and/or may be adjusted in response to detected attacks, either manually or automatically.

The present invention is usable on such networks as ARCnet, Ethernets and Token-Ring networks, wireless networks, among other network types. The network, in this example, has a network cable, also known as media, which may be of any known physical configuration including unshielded twisted pair (UTP) wire, coaxial cable, shielded twisted pair wire, fiber optic cable, and the like. Alternatively, the network devices could communicate across wireless links.

The system of the present invention is designed and intended to operate compatibly on networks which communicate using the Transmission Control Protocol/Internet Protocol (TCP/IP) standard, although other communications standards (or even proprietary protocols) could be used. Network TCP/IP data is packetized, and sent in frames which are structured to be compatible with any network device which complies with the TCP/IP standards. A typical frame or packet transmitted across the Internet contains a preamble, destination address, source address, type field, data field, and a cyclical redundancy check (CRC). The preamble contains data used by the communicating computer systems to synchronize or handshake. Destination and source Internet Protocol (IP) addresses represent the principals communicating and the packet type indicates the type of communication. The data field contains the actual information content of the dialogue. The CRC is an integrity check facilitated between the two systems participating in the conversation.

The present invention provides aggregate traffic/intrusion monitoring in the provider network. This allows for a broader scope of network activity to be considered and analyzed, not just relevant to a single customer, but across some or all customers. The additional data is valuable because the probing/reconnaissance activities of would-be intruders typically cover a large number of customers, so as to select those with security weaknesses for more in-depth attack. Additional patterns of broadly suspicious activity can thus be correlated/recognized across many customers.

The present invention uses a multi-stage technique in order to improve intrusion detection efficacy and obtain broader scope detection. First, suspicious network traffic events are collected (potentially in context) and forwarded to a central database and analysis engine, then the centralized engine uses pattern correlations across multiple customer's events in order to better determine the occurrence and sources of suspected intrusion-oriented activity prior to actually alarming. Second, upon detection of suspected reconnaissance and probing, the detection process can adjust its matching parameters and alarm thresholds to focus sensitivity on attacks from suspected sources (hackers) against specific targets (customers). Third, actual occurrence of anticipated attacks against specific targets can be used to adjust the broad-scope matching parameters, providing both positive and negative feedback which selectively adjusts specific pattern sensitivity. This process is different from conventional approaches, in that a broader scope of data is utilized in new ways. It should be noted that, in addition to multi-stage techniques, the present invention can implement monolithic techniques in which a broad scope of customers' events are correlated at a central analysis engine.

The system analyzes traffic coming into multiple hosts or other customer's computers or site. This provides additional data for analysis as compared to systems that just analyze the traffic coming into one customer's site (as a typical firewall does). Therefore, additional detection schemes can be used to recognize patterns that would otherwise be difficult or impossible to recognize with just a single customer detector. Standard scanning patterns can be used for the data as well, such as sequential or pseudorandom techniques.

The data collection and processing center collects data from multiple or all the customers and analyzes the data. In this manner, the number of false alarms is decreased (because multiple occurrences of an activity may trigger an alarm, but the present invention can scan a large number of customers, so certain types of harmless activity that otherwise would be perceived as a threat can be viewed and discounted as not a threat). Moreover, predictions can be made about future events that may affect customers in the sequence. Thus, the present invention can be used to block future hacks and determine the source address of the hacker.

The present invention monitors the traffic from a plurality of customers. Different types of algorithms can be used to look for different types of patterns that would not be recognizable by a conventional intrusion detection system at a single customer site. The algorithms preferably reside in a back end data center. Data from existing customer's conventional intrusion detection system is provided to the central database and then analyzed. Data records comprise, for example, a time-stamp, a description of the activity, and the source of the probe.

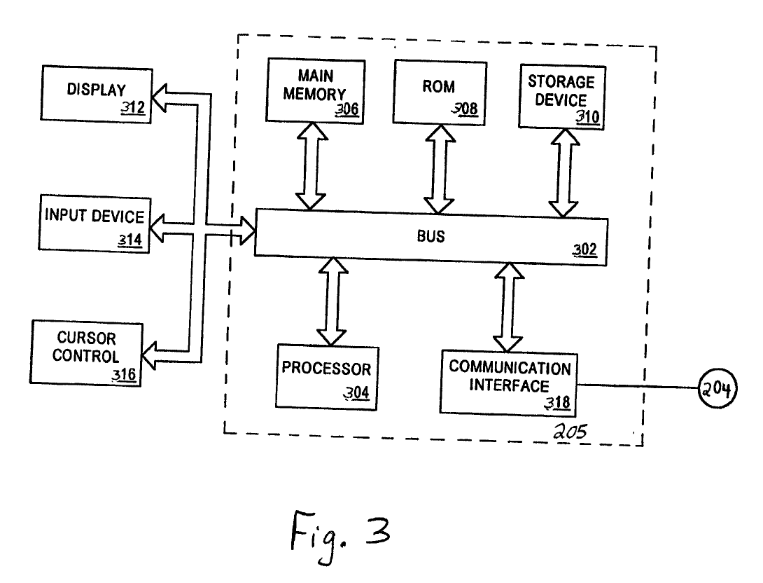

FIG. 3 is a detailed block diagram of an exemplary computer system 205 of a data collection and processing center with which the present invention can be used. The system includes a bus 302 or other communication mechanism for communicating information, and a processor 304 coupled with the bus 302 for processing information. The system also includes a main memory 306, such as a random access memory (RAM) or other dynamic storage device, coupled to the bus 302 for storing information and instructions to be executed by processor 304. Main memory 306 also may be used for storing temporary variables or other intermediate information during execution of instructions to be executed by processor 304. The system further includes a read only memory (ROM) 308 or other static storage device coupled to the bus 302 for storing static information and instructions for the processor 304. A storage device 310, such as a magnetic disk or optical disk, is provided and coupled to the bus 302 for storing information and instructions.

The system 205 may be coupled via the bus 302 to a display 312, such as a cathode ray tube (CRT) or a flat panel display, for displaying information to a computer user. An input device 314, including alphanumeric and other keys, is coupled to the bus 302 for communicating information and command selections to the processor 304. Another type of user input device is cursor control 316, such as a mouse, a trackball, or cursor direction keys for communicating direction information and command selections to processor 304 and for controlling cursor movement on the display 312.

The system 205 also includes a communication interface 318 coupled to the bus 302. Communication interface 318 provides a two-way data communication as is known. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Furthermore, the communication interface 318 may be coupled to the network cable 302. Wireless links may also be implemented. In any such implementation, communication interface 318 sends and receives electrical, electromagnetic or optical signals which carry digital data streams representing various types of information. Of particular note, the communications through interface 318 permits the transmission or receipt of broad-scope intrusion detection information.

The system 205 receives data from each of the nodes being monitored on the network. The system 205 collects the data, filters the data, and processes the data to provide security indications and warnings.

The processor 304 can execute sequences of instructions contained in the main memory 306. Such instructions may be read into main memory 306 from another computer-readable medium, such as storage device 310. However, the computer-readable medium is not limited to devices such as storage device 310. For example, the computer-readable medium may include a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave embodied in an electrical, electromagnetic, infrared, or optical signal, or any other medium from which a computer can read. Execution of the sequences of instructions contained in the main memory 306 causes the processor 304 to perform the process steps described below. In alternative embodiments, hard-wired circuitry may be used in place of or in combination with software instructions to implement the invention. Thus, embodiments of the invention are not limited to any specific combination of hardware circuitry and software.

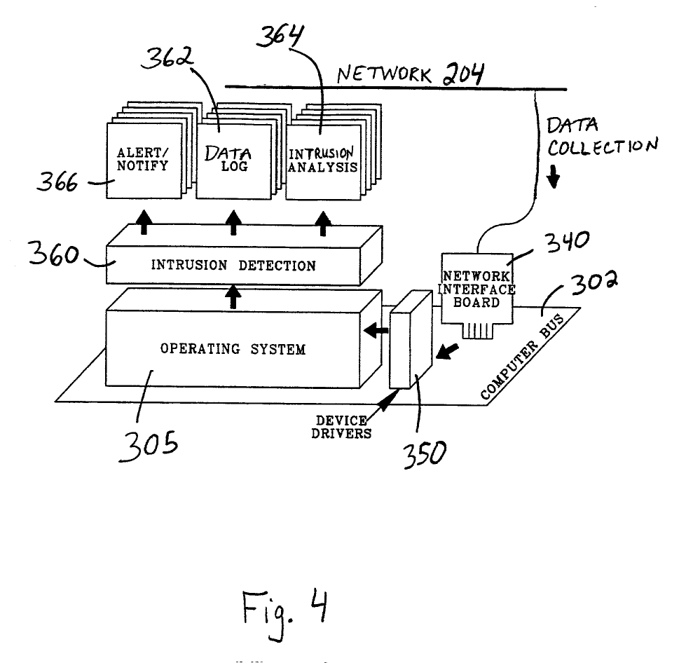

FIG. 4 shows in block form aspects of the system 205 in accordance with the present invention. The intrusion detection portion of the system receives data from the various intrusion detection systems on the network and analyzes this data to detect an attempted intrusion or an intrusion or reconnaissance activity. The data is logged and analyzed. If an intrusion is detected, an alert is logged.

The broad-scope intrusion monitoring system operates through a computer, attached to the network, in the preferred embodiment by an interface card or network interface board 340. In the preferred embodiment, the network interface board 340 contains a preset and unique identifier such as an Internet address or a hardware address. The unique address provides the means for an attached computer system to identify intended packets and ignore the rest, as is well known in the art. The system utilizes standard device drivers 350 to forward all packets into the host 205 from the network 204 regardless of the address in the packets. Preferably, the system is transparent and inaccessible to an intruder, thereby preserving the authenticity of the logged entries made by the system. To this end, encryption and authentication means can be used, as known to those skilled in the art.

The system preferably monitors the network traffic substantially in its entirety. Upon receipt of the network packets, the interface board 340 passes the packet and all data contained within to the operating system 305 of the system computer. Once there, it is stored in memory (e.g., memory 306) awaiting entry to the next phase which is the intrusion detection process 360, described below. In the intrusion detection process, the data is first logged into a data log 362. The data is then analyzed 364, and alerts or notifications 366 are thereafter generated.

The computer equipment configuration which may be used in the preferred embodiment may be, for example, conventional computer running a conventional operating system, available as commercial-off-the-shelf products as known to one skilled in the art.

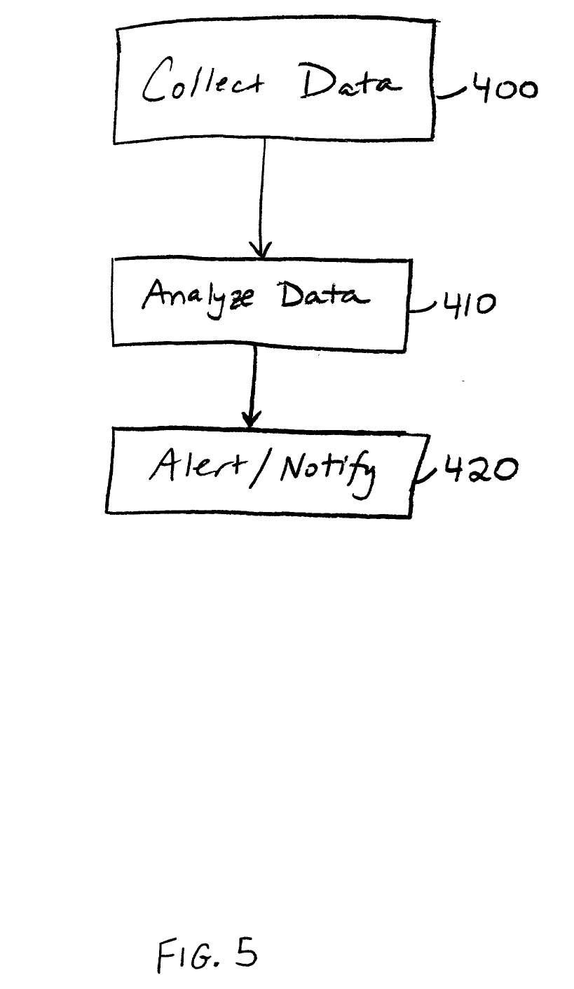

FIG. 5 shows a flow chart of an exemplary intrusion detection method in accordance with the present invention. At step 400, data is collected or otherwise received at the data collection and processing center from the sensors coupled to the network, whether they be computers or special-purpose devices. Preferably, the data is collected in a predetermined order from the hosts. At step 410, the data is analyzed to determine if any intrusions have been (or are being) attempted. At step 420, if any intrusions or attempted intrusions or reconnaissance activity have been detected, the appropriate alerts or notifications are transmitted to the pertinent administrators of the hosts on the network. In this manner, the administrators, and thereby the hosts for which they are responsible, can be prepared for an incoming intrusion, or can take other precautions against future intrusions, or can check their systems to determine if any access was gained in previous intrusion attempts. Because the data is determined in a predetermined order from the sensors, an intrusion attempt that is detected at an earlier, already polled sensor, can be determined and administrators of other hosts, that have not yet been hit by the intrusion attempt, can be alerted about the possibility of such an intrusion attempt. Thus, the present invention gathers and exploits intrusion monitoring data related to many customers rather than just a single customer, thereby reducing inaccurate declarations of intrusion events and more readily detecting the earliest stages of attempted attacks.

The process preferably includes analysis at each stage, and more preferably after the initial detection of initial suspicious events. The analysis results in determinations, some of which may be reportable results/events, while other determinations may be used to adjust modes, algorithms, etc. for further monitoring and analysis which will again result in determinations. The number of iterations and additional analysis stages implemented depends on the specific attack(s) postulated or predicted by the system as it progresses.

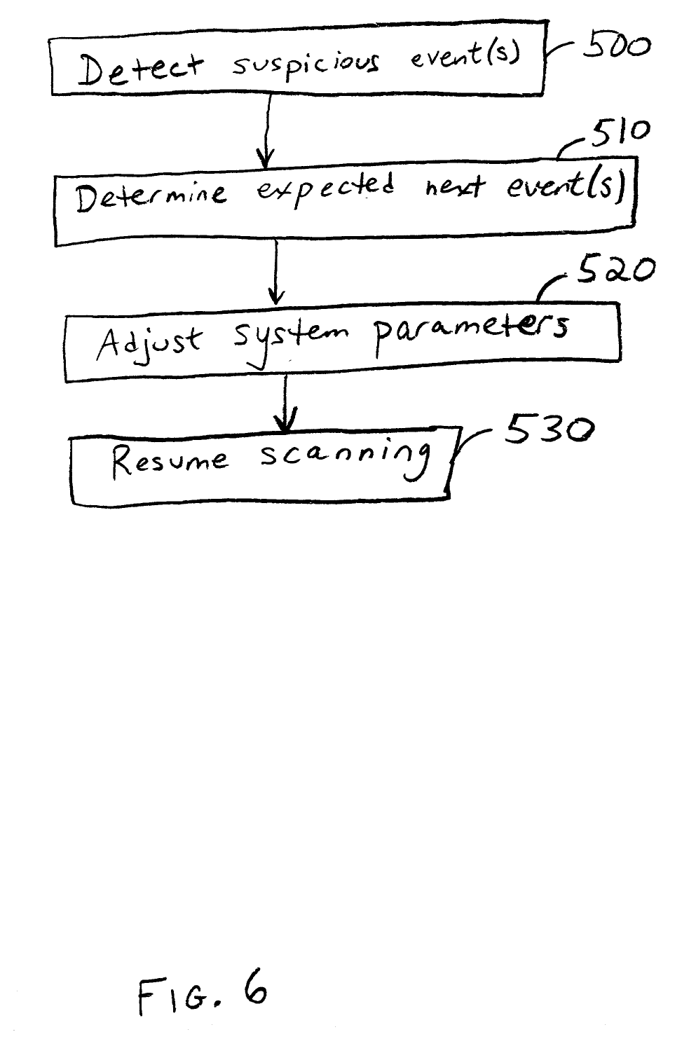

An exemplary process is described with respect to FIG. 6. At step 500, initial suspicious events are detected. At step 510, the events are analyzed to determine expected next events or associated events. Broad-scope intrusion detection system parameters are then adjusted at step 520. For example, appropriate signature/patterns/databases are selected, along with particular specific mathematical algorithms or heuristics. At step 530, scanning resumes with a switch between modes and sub-modes such as statistical, expert system, and signature detection, for example, as desired.

Expected hacker scanning is searched for across a broad-scope by techniques such as, for example, (1) incrementing/decrementing IP address hacker scans; (2) incrementing/decrementing port number hacker scans; and (3) pseudo-random scans which may appear random at first glance, but still have a mathematical deterministic, i.e., a non-random pattern that can be identified.

Furthermore, patterns in hacker switching between different types of scans is searched for, such as, for example, repeated looping through all or some of the following: (1) basic port scan in general; (2) scans of well-known ports (e.g. windows networking ports), to gather specific information for exploitation, or to do specific attack types; (3) SYN/ACK “acknowledge” or FIN “reset” “stealth” scans, which are meant to gather information without alarming administrators or security monitors; (4) inverse probes, which seek to find out where things “are not,” as opposed to where things “are”; (5) distributed probing, where probes or scans come from multiple coordinated sources, e.g., cooperating probes; and (6) router probes, i.e., scans of network infrastructure rather than hosts, seeking to gather information on network topology, etc.

Additionally, use of special packets or transmissions is also searched for, such as, for example, (1) special packets of packet configurations, sometimes used by hackers, which are not normally seen or not normally present in particular circumstances; and (2) special hacker methods including use of timings between packets or scans intended to discover information used to infer operating system type and versions and other system particulars, e.g., to aid the hacker in various specific attacks.

Broad-scope matching against known hacking methods is performed by searching for, for example, (1) automated and semi-automated hacker toolkit software operation, processes, etc. such that the toolkit in use can be identified, allowing next events to be predicted (this assumes that the toolkit has been studied and characterized, which is typically the case for most hacker toolkits); (2) known manual attack or probing sequences; and (3) known manual attack or probing tools, i.e., with identifiable characteristics.

It should be understood that the inventive principles described in this application are not limited to the components or configurations described in this application. It should be understood that the principles, concepts, systems, and methods shown in this application may be practiced with software programs written in various ways, or different equipment than is described in this application without departing from the principles of the invention.

Although illustrated and described herein with reference to certain specific embodiments, the present invention is nevertheless not intended to be limited to the details shown. Rather, various modifications may be made in the details within the scope and range of equivalents of the claims and without departing from the invention.

What is claimed is:

1. An intrusion detection system for a computer network comprising:
a plurality of devices coupled to the computer network, each device adapted to at least one of: sense data and provide the data to a data collection and processing center, and be adjustable; and
the data collection and processing center comprising a computer with a firewall coupled to the computer network, the data collection and processing center monitoring data communicated from the plurality of devices coupled to the network.

2. The system of claim 1, wherein the plurality of devices comprises at least one of a host, a server, and a personal computer.

3. The system of claim 1, further comprising a firewall associated with at least one of the plurality of devices, each firewall connecting the associated device to the computer network.

4. The system of claim 1, wherein the data collection and processing center further comprises a storage device comprising a plurality of pattern recognition techniques.

5. The system of claim 4, wherein the pattern recognition techniques comprise at least one of sequential and pseudorandom algorithms.

6. The system of claim 1, wherein the data collection and processing center further comprises a bus, a processor coupled to the bus, a storage device coupled to the bus, and a communications interface that couples the data collection and processing center to the plurality of devices via an authenticated secured connection.

7. The system of claim 6, wherein the processor executes a plurality of pattern recognition algorithms on the data received from at least one of the plurality of devices coupled to the network.

8. The system of claim 1, wherein the data collection and processing provides an alarm if the data indicates an anomaly.

9. The system of claim 1, wherein the computer network is one of a wired local network and a wireless network.

10. The system of claim 1, wherein the data collection and processing center is coupled to the computer network via one of a wired link and a wireless link.

11. A method of detecting an anomaly in a networked computer system having a plurality of devices networked together, comprising:
receiving data at at least one of the plurality of devices from at least one of a plurality of sources;
providing the data from the plurality of devices to an analysis engine; and
analyzing the data to detect an anomaly.

12. The method of claim 11, wherein the data is provided to the analysis engine in a predetermined order from the plurality of devices.

13. The method of claim 11, wherein the analyzing comprises performing a plurality of pattern recognition techniques having associated matching parameters and thresholds on the data.

14. The method of claim 13, further comprising adjusting at least one of the matching parameters and the thresholds responsive to detecting the anomaly.

15. The method of claim 14, wherein adjusting comprises adjusting the at least one of the matching parameters and the thresholds to focus on one of the plurality of devices.

16. The method of claim 14, wherein adjusting comprises adjusting the at least one of the matching parameters and the thresholds to focus on one of the sources.

17. The method of claim 13, further comprising:
determining a device to be targeted based on the detected anomaly;
determining whether the device to be targeted has been acquired as an intrusion target; and
adjusting at least one of the matching parameters and the thresholds responsive to whether the device to be targeted has been acquired as the intrusion target.

18. The method of claim 13, wherein the pattern recognition techniques comprise at least one of sequential and pseudorandom techniques.

19. The method of claim 11, further comprising determining a device to be targeted based on the detected anomaly.

20. The method of claim 11, wherein providing the data comprises providing suspicious network traffic events to the analysis engine.

21. The method of claim 11, further comprising alarming a host in the networked computer system of the anomaly responsive to detecting the anomaly.

22. The method of claim 11, wherein providing the data to the analysis engine comprises providing the data via an authenticated secured connection between each of the devices and the analysis engine.
